(19) United States
(12) Patent Application Publication
(10) Pub. No.: US 2016/0221317 A1
(43) Pub. Date: Aug. 4, 2016

(54) FILM AND COMPOSITE FABRIC

(71) Applicant: SMP Technologies Inc., Tokyo (JP)

(72) Inventor: Shunichi HAYASHI, Tokyo (JP)

(73) Assignee: SMP Technologies Inc., Tokyo (JP)

(21) Appl. No.: 15/008,965

(22) Filed: Jan. 28, 2016

(30) Foreign Application Priority Data
Jan. 30, 2015 (JP) 2015-017206

(51) Int. Cl. B32B 27/40; B32B 5/02; B32B 3/26; B32B 27/12

(52) U.S. Cl. CPC B32B 27/40; B32B 27/12; B32B 5/022; B32B 5/024; B32B 3/266; B32B 2305/188

(57) ABSTRACT

The provision of a film which is comfortable when worn on the human body, both when the body is at rest as well as when the body is in motion and which is also capable of reinforcing the movement of the human body, particularly during exercise, as well as a composite fabric containing said film. A composite fabric composed of a fabric, as well as a synthetic resin layer which covers part of the surface of at least one side of said fabric, wherein the synthetic resin layer is composed primarily of a polyurethane elastomer produced by via the polymerization of a bifunctional diisocyanate, bifunctional polyol and bifunctional chain extender using the pre-polymer method at a molar ratio of 2.00 to 1.10:1.00:1.00 to 0.10, and the coverage ratio of the synthetic resin layer relative to the surface of the fabric ranges from 10 to 90% (inclusive).

### CROSS-REFERENCE TO RELATED APPLICATIONS

This application claims the benefit of Japanese Patent Application No. 2015-017206 filed in Japan on Jan. 30, 2015, the content of which is incorporated herein by reference.

### TECHNICAL FIELD

The present invention relates to a film which is comfortable when worn on the human body, both when the body is at rest as well as when the body is in motion and which is also capable of reinforcing the movement of the human body, as well as a composite fabric containing said film.

### BACKGROUND ART

Foams (Japanese Unexamined Patent Application, Publication No. 2009-35697) as well as fabrics such as textiles and knitted articles (Japanese Unexamined Patent Application, Publication No. Hei 2-92914) comprising polymers which hold shape memory properties, are known. It is possible to deform these foams and fabrics to a desired shape at temperatures above their glass-transition temperature (e.g. the polymer flow temperature) and by directly reducing the temperature to below the corresponding glass-transition temperature, said foams and fabrics will retain a memory of the desired shape.

Moreover, Japanese Unexamined Patent Application, Publication No. 2011-149108 discloses a type of fabric with a glass-transition temperature close to room temperature which shows a mechanical dynamic loss tangent peak value which is almost identical to the mechanical dynamic loss tangent on the surface of the human body within the same temperature range. Fabrics which have the characteristics above are comfortable when worn on the human body both when the body is at rest as well as when the body is in motion.

### SUMMARY OF INVENTION

### Technical Problem

The present invention aims to provide a film which is comfortable when worn on the human body, both when the body is at rest as well as when the body is in motion and which is also capable of reinforcing the movement of the human body, particularly during exercise, as well as a composite fabric containing said film.

### Solution to Problem

The First Embodiment of the present invention is a film which is primarily composed of a polyurethane elastomer produced by via the polymerization of a bifunctional diisocyanate, bifunctional polyol and bifunctional chain extender using the pre-polymer method at a molar ratio of 2.00 to 1.10:1.00:1.00 to 0.10, which has multiple apertures at an aperture ratio of ranging from 10 to 90% (inclusive).

For the First Embodiment, the molecular weight of the bifunctional diisocyanate should preferably range from 174 to 303, the molecular weight of the bifunctional polyol should preferably range from 300 to 2,500, and the bifunctional chain extender should preferably be a diol or diamine with a molecular weight ranging from 60 to 360.

The Second Embodiment of the present invention is a composite fabric composed of a fabric produced from natural fiber, synthetic fiber or a mixed fiber containing both the natural fiber and the synthetic fiber, as well as a synthetic resin layer which covers part of the surface of at least one side of said fabric, wherein the synthetic resin layer is composed primarily of a polyurethane elastomer produced by via the polymerization of a bifunctional diisocyanate, bifunctional polyol and bifunctional chain extender using the pre-polymer method at a molar ratio of 2.00 to 1.10:1.00:1.00 to 0.10, and the coverage ratio of the synthetic resin layer relative to the surface of the fabric ranges from 10 to 90% (inclusive).

For the Second Embodiment, the molecular weight of the bifunctional diisocyanate should preferably range from 174 to 303, the molecular weight of the bifunctional polyol should preferably range from 300 to 2,500, and the bifunctional chain extender should preferably be a diol or diamine with a molecular weight ranging from 60 to 360.

The film shows a glass-transition temperature close to the temperature of the surface of the human body. Furthermore, the mechanical dynamic loss tangent of the film (tan δ) is high both when the human body as at rest as well as during exercise and the storage elastic modulus E′, loss elastic modulus E″ and tan δ are higher during exercise than when the body is at rest. The inventors of the present invention discovered that, by applying the film to a fabric, this property shows a similar trend even in the event that a composite fabric is produced by forming a synthetic resin layer which does not completely cover the fabric onto the surface of the fabric. The film and composite fabric according to the present invention not only reinforce the movement of the human body's muscles during exercise, they are also comfortable when worn on the human body, both when the body is at rest as well as when the body is in motion. Additionally, the film and composite fabric according to the present invention show superior breathability while also being light weight.

For the First Embodiment, the number of apertures per unit area should preferably range from 30 /cm² to 150 /cm² (inclusive).

For the Second Embodiment, the synthetic resin layer contains multiple apertures, and the aperture ratio of the synthetic resin layer should preferably range from 10 to 90% (inclusive) while the number of apertures per unit area should preferably range from 30 /cm² to 150 /cm² (inclusive). Furthermore, for the aforementioned embodiment the synthetic resin layer should preferably be a continuous film.

The film as well as a composite fabric on which the synthetic resin layer is established are capable of ensuring superior muscle support performance and breathability.

### Advantageous Effects of Invention

The film and composite fabric according to the present invention not only reinforce the movement of the human body's muscles during exercise, they are also comfortable when worn on the human body, both when the body is at rest as well as when the body is in motion. Additionally, the film and composite fabric according to the present invention show superior breathability while also being light weight.

### BRIEF DESCRIPTION OF DRAWINGS

FIG. 1 is a schematic perspective view of a composite fabric according to one Embodiment of the present invention.

FIG. 2 is a schematic diagram showing the composite fabric featured in FIG. 1 from the synthetic resin layer.

FIG. 3 is a schematic perspective view of a composite fabric according to another embodiment of the present invention.

FIG. 4 is a schematic perspective view of a composite fabric according to another embodiment of the present invention.

FIG. 5 is a schematic perspective view of a composite fabric according to another embodiment of the present invention.

FIG. 6 is a schematic perspective view of a composite fabric according to another embodiment of the present invention.

FIG. 7 is a graph showing the temperature dependence of the dynamic viscoelasticity of the composite fabric referred to in Example 1.

FIG. 8 is a graph showing the temperature dependence of the dynamic viscoelasticity of the fabric referred to in Comparative Example 1.

FIG. 9 is a graph showing the temperature dependence of the dynamic viscoelasticity of the fabric referred to in Comparative Example 2.

FIG. 10 is a graph showing the frequency dependence of the dynamic viscoelasticity of the composite fabric referred to in Example 1.

FIG. 11 is a graph showing the frequency dependence of the dynamic viscoelasticity of the fabric referred to in Comparative Example 1.

FIG. 12 is a graph showing the frequency dependence of the dynamic viscoelasticity of the fabric referred to in Comparative Example 2.

### DESCRIPTION OF EMBODIMENTS

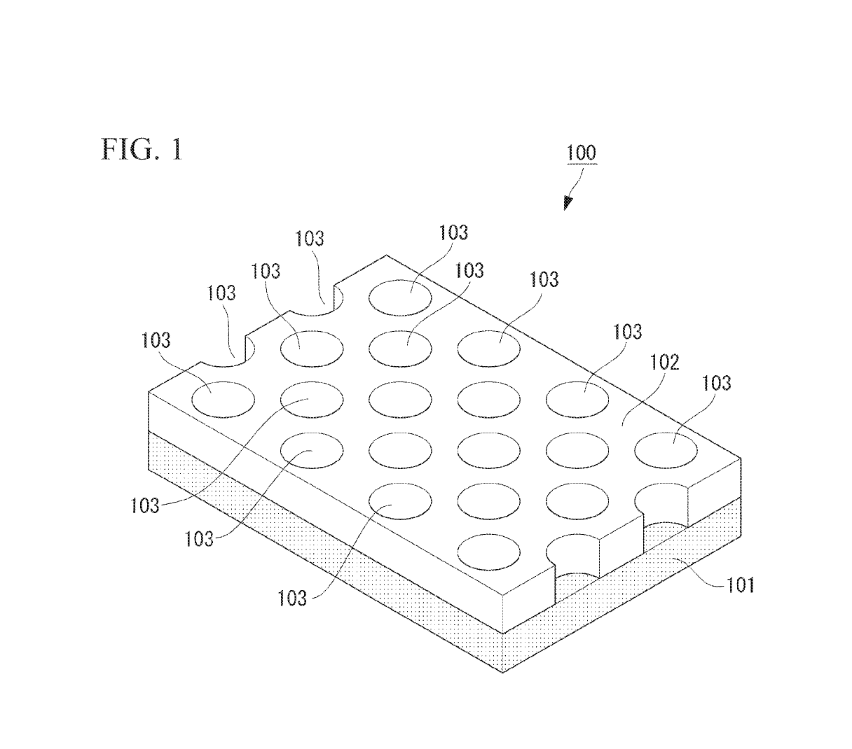

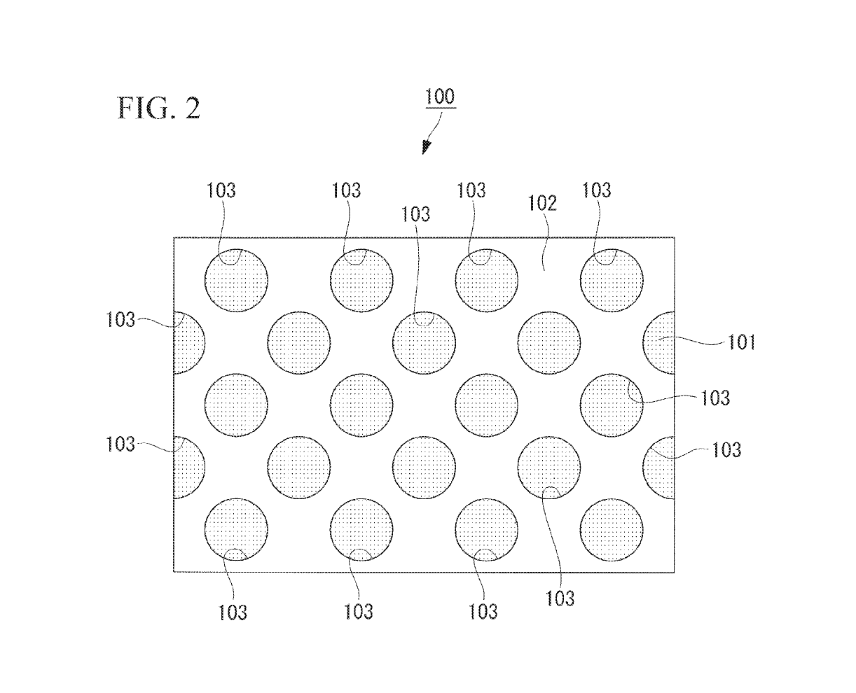

FIGS. 1 and 2 are figures which show a composite fabric according to the First Embodiment of the present invention. FIG. 1 is a schematic perspective view of the composite fabric. The composite fabric corresponding to the present embodiment [100] is composed of a fabric [101] and a synthetic resin layer [102].

Said fabric [101] can be a knitted, woven or non-woven fabric. The fabric [101] is made from natural fiber, synthetic fiber or a mixed fiber containing both natural fiber and synthetic fiber. Natural fibers include cotton, wool, etc. Chemical fibers include Nylon fibers such as Nylon 6 and Nylon 6,6, polyester fibers such as PET (polyethylene terephthalate) and polypropylene fibers.

The synthetic resin layer [102] is formed on one side of the fabric [101]. The thickness of the synthetic resin layer [102] ranges from 20 to 1,000 μm (inclusive). The synthetic resin layer [102] contains as primary raw materials a bifunctional isocyanate, bifunctional polyol and chain extender.

For the present embodiment, a bifunctional isocyanate with a molecular weight ranging from 174 to 303 is used. Specific examples include 2,4-toluene diisocyanate, 4,4′-diphenyl methane diisocyanate, carbodiimide-modified 4,4′-diphenylmethane diisocyanate and hexamethylene diisocyanate.

For the present embodiment, a bifunctional polyol with a molecular weight ranging from 300 to 2,500 is used. Specific examples include polypropylene glycol, 1,4-butane glycol adipate, polytetramethylene glycol, polyethylene glycol, and propylene oxide adducts of bisphenol-A. The bifunctional polyol can also be further modified by reacting it with a bifunctional carboxyllic acid or cyclic ether.

A diamine or diol with a molecular weight ranging from 60 to 360 is used as a chain extender. Examples of the diols which can be used for the present embodiment include ethylene glycol, 1,4-butane glycol, bis(2-hydroxyethyl)hydroquinone, ethylene oxide adducts of bisphenol-A and propylene oxide adducts of bisphenol-A. Examples of the diamines which can be used for the present embodiment include ethylene diamine.

The bifunctional diisocyanate, bifunctional polyol and bifunctional chain extender are used at a molar ratio of 2.00 to 1.10:1.00:1.00 to 0.10.

The synthetic resin layer [102] is formed such that it covers a portion of the fabric [101]. FIG. 2 shows a view of the composite fabric [100] shown in FIG. 1 from the top (the synthetic resin layer [102] side). In the example shown in FIGS. 1 and 2, the synthetic resin layer [102] forms a single continuous film over the surface of the fabric [101]. The synthetic resin layer [102] contains multiple circular apertures [103]. The apertures [103] penetrate through the synthetic resin layer [102].

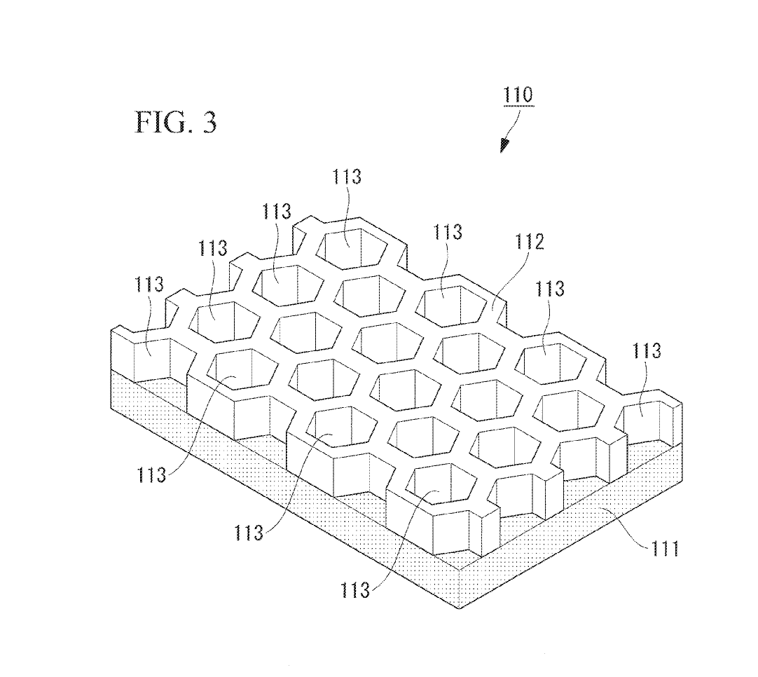

FIG. 3 is a schematic perspective view of a composite fabric with hexagonal apertures which constitutes another embodiment. For the composite fabric [110] shown in FIG. 3, the synthetic resin layer [112] forms a single continuous film over the surface of the fabric [111]. Multiple hexagonal apertures [113] which penetrate through the synthetic resin layer [112] are established on the synthetic resin layer [112].

The shape of the apertures used is not restricted in any particular way. Shapes (as viewed from the top) which can be used for the apertures include ellipses, polygons such as triangles, etc. and rounded polygons. If a shape which does not contain any corners, such as a circle, ellipse, or rounded polygon, is used, the possibility that the corners of the apertures might serve as a fracture origin for the synthetic resin layer when the composite fabric is pulled is eliminated, making it possible to prevent damage to the synthetic resin layer.

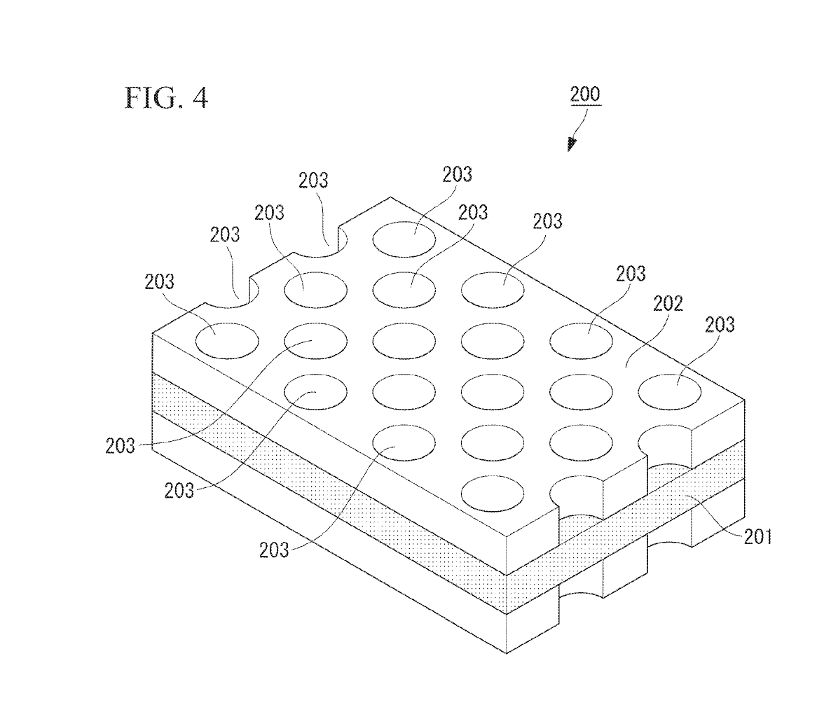

FIG. 4 is a schematic perspective view of a composite fabric according to another embodiment. For the composite fabric [200] shown in FIG. 4, a synthetic resin layer [202] containing apertures [203] which are the same shape as those shown in FIGS. 1 and 2 is formed over both surfaces of the fabric [201]. The shape of the apertures is not limited in any particular way and other shapes, such as the hexagonal shape shown in FIG. 3, can be employed.

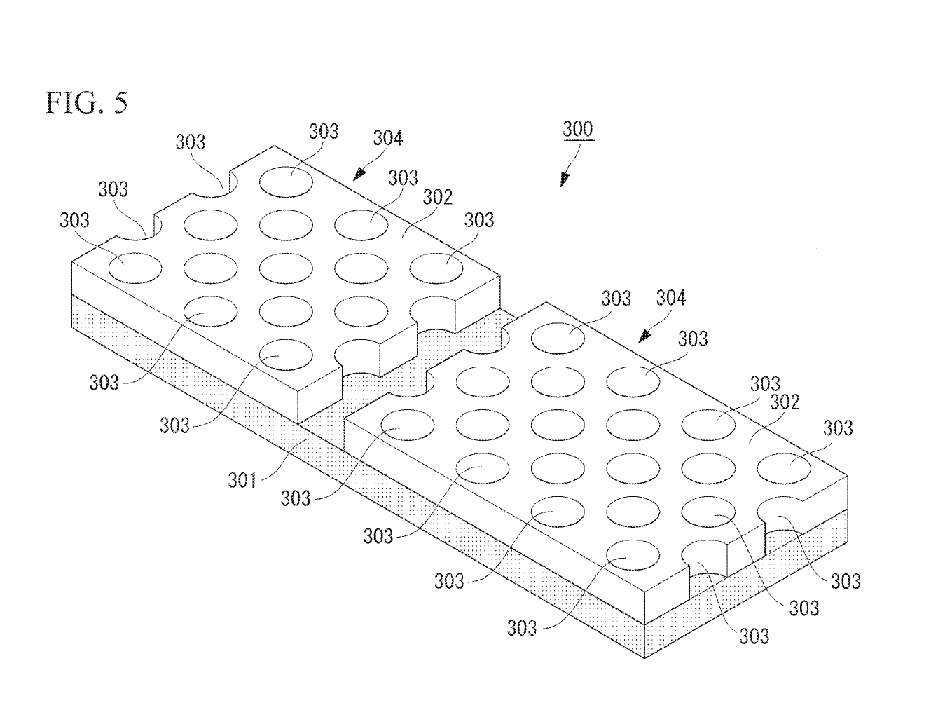

FIG. 5 is a schematic perspective view of a composite fabric according to another embodiment. For the composite fabric [300] shown in FIG. 5, the synthetic resin layer [302] is formed over the surface of the fabric [301] such that it is divided into multiple blocks [304], with each single block [304] constituting a continuous film containing multiple apertures [303]. Although the shape of the block [304] shown in FIG. 5 is that of a quadrangle, other shapes, including circles and polygons such as triangles and hexagonales, etc., can be used. The distance between blocks [304] is set as needed taking into consideration the breathability, comfort upon wearing as mentioned below and support capabilities of the composite fabric [300].

The shape of the apertures [303] is not restricted to circular, and other shapes, including ellipses, rounded polygons and regular polygons may be used.

Although on FIG. 5 shows an example in which the synthetic resin layer [302] is formed over one side of the fabric [301], the synthetic resin layer may also be formed over both sides of the fabric [301].

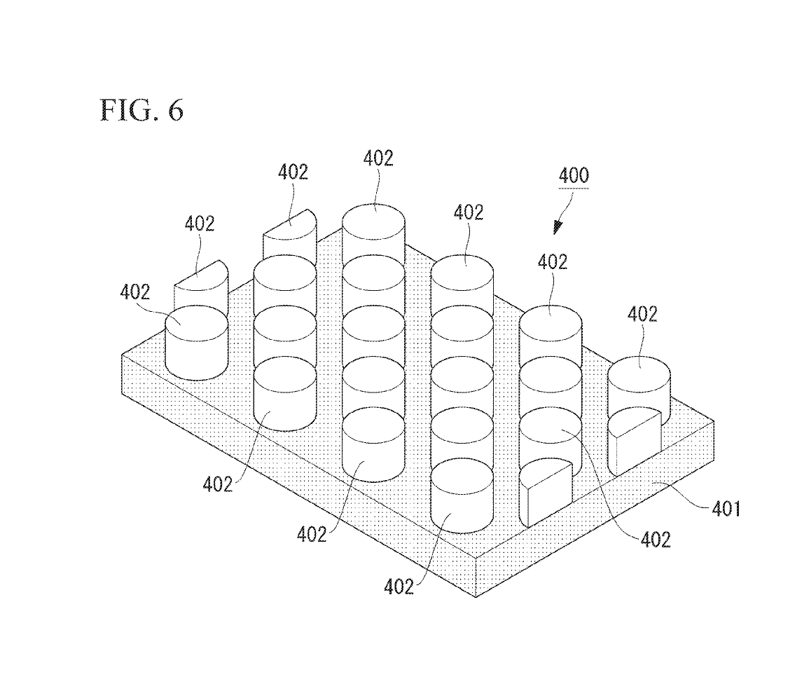

FIG. 6 is a schematic perspective view of a composite fabric according to another embodiment. For the composite fabric [400] shown in FIG. 6, the synthetic resin layer [402] is formed over the surface of the fabric [401] such that it forms mutually isolated islands. When the specimen shown in FIG. 6 is viewed from the top (the synthetic resin layer [402] side), the synthetic resin layer [402] appears circular in shape. In this case, no apertures are formed within the synthetic resin layer [402].

There are no particular restrictions imposed on the shape of the synthetic resin layer [402]. For example, when looking at the synthetic resin layer [402] from the top, the synthetic resin layer [402] can be formed into ellipses, polygons, etc.

The coverage ratio of the synthetic resin layer [102, 112, 202, 302, 402] relative to the surface of the fabric [101, 111, 201, 301, 401] ranges from 10 to 90% (inclusive) and a range of 50 to 80% (inclusive) is preferred.

In the event that the synthetic resin layer [102, 112, 202] is a continuous film containing apertures [103, 113, 203], the aperture ratio of the synthetic resin layer [102, 112, 202] ranges from 10 to 90% (inclusive), while a range of 20 to 50% (inclusive) is preferred. If the synthetic resin layer [102, 112, 202] contains apertures [103, 113, 203], the number of apertures per unit area ranges from 30 /cm² to 150 /cm² (inclusive).

In the event that a block [304] is a continuous film containing apertures [303], the aperture ratio of the synthetic resin layer [302] (block [304]) will similarly range from 10 to 90% (inclusive), with a range of 20 to 50% (inclusive) preferred. Additionally, the number of apertures per unit area ranges from 30 /cm² to 150 /cm² (inclusive).

Thus, because the synthetic resin layer [102, 112, 202, 302, 402] does not completely cover the fabric [101, 111, 201, 301, 401], the composite fabric according to the present embodiment [100, 110, 200, 300, 400] shows superior breathability and is light weight.

The synthetic resin layer [102, 112, 202, 302, 402] is formed by applying a film with the aforementioned aperture shape onto the fabric [101, 111, 201, 301, 401]. The film can be formed via intaglio printing techniques, including gravure printing. A suitable catalyst can be added and melted into the bifunctional diisocyanate, bifunctional polyol and bifunctional chain extender mixture prepared at the aforementioned ratio as needed to prepare a molten synthetic resin material. Given formability considerations, the molten synthetic resin material should show a viscosity ranging from 500 to 5,000 Pa·s at the relevant molding temperature (190 to 230° C.) with a range of 1,000 to 2,000 Pa·s preferable. The type (molecular weight) and relative proportions of the bifunctional diisocyanate, bifunctional polyol and bifunctional chain extender are selected in order to satisfy the above viscosity constraints.

A plate corresponding to the shape of the synthetic resin layer [102, 112, 202, 302, 402] is set within a printing apparatus. Prepared molten synthetic resin material is fed onto the printing apparatus plate and printed onto a release sheet. In this way a film is prepared on the release sheet.

Next, the release sheet is bonded to the fabric [101, 111, 201, 301, 401]. When the release sheet is peeled off, the film is transferred onto the fabric [101, 111, 201, 301, 401] to form a synthetic resin layer [102, 112, 202, 302, 402].

Alternatively, a synthetic resin film constituting a single continuous film can be formed on the fabric [101, 111, 201, 301], after which part of the film is removed, in order to form a synthetic resin layer [102, 112, 202, 302]. For example, the aforementioned starting material can be cross-linked, after which it is mixed with a suitable solvent to prepare a synthetic resin solution. The aforementioned synthetic resin solution is then applied to the surface of the fabric [101, 111, 201, 301] using known methods (e.g., screen printing). Subsequently, part of the synthetic resin film is removed via mechanical puncturing or laser treatment.

The synthetic resin layer [102, 112, 202, 302, 402] is composed of synthetic resin which has a glass transition temperature ranging between 0 and 40° C. The glass transition point refers to the temperature at which the mechanical properties of a polymer elastomer abruptly changes and in the context of the present embodiment the glass transition point is defined as the temperature at which the mechanical dynamic loss tangent (hereafter referred to as tan δ) peaks. Here tan δ is the tangent of the ratio of the loss elastic modulus E″ to the storage elastic modulus E′ (E″/E′) at the temperature of the surface of the human body. The glass transition temperature should preferably be close to the surface temperature of the human body, ranging from 25 to 35° C.

The aforementioned property is measured when the synthetic resin exists as a film, and even in the case of a composite fabric [100, 110, 200, 300, 400] the glass-transition temperature should fall within a range of 0 to 40° C., with a range of 25 to 35° C. preferable. Thus, the composite fabric according to the present embodiment [100, 110, 200, 300, 400] is comfortable when worn on the human body.

The synthetic resin layer [102, 112, 202, 302, 402] shows a high tan δ within the frequency range of the surface of the human body (0.1 to 100 Hz).

The frequency of the surface of the human body at rest corresponds to 0.1 to 1 Hz. The frequency of the surface of the human body during exercise corresponds to 10 to 100 Hz. The synthetic resin constituting the synthetic resin layer according to the present embodiment [102, 112, 202, 302, 402] shows a higher storage elastic modulus E′ as well as a higher loss elastic modulus E″ at frequencies which correspond to exercise versus frequencies which correspond to a rest state.

The aforementioned property is measured when the synthetic resin exists as a film, and even in the case of a composite fabric [100, 110, 200, 300, 400] the trend in frequency dependence observed for E′, E″ and tan δ is the same as when only the synthetic resin is analyzed. Thus, the composite fabric according to the present embodiment [100, 110, 200, 300, 400] reinforces the motion of human muscles during exercise without burdening the muscles during rest. Thus, the composite fabric according to the present embodiment [100, 110, 200, 300, 400] is comfortable when worn on the human body, both when the body is at rest as well during exercise.

The film and composite fabric according to the present embodiment can be used in sports underwear, compensating underwear, sporting goods and rehabilitation garb worn after surgery (including bandages).

### EXAMPLE 1

For Example 1, a film was formed over a release sheet using gravure printing and the release sheet was applied to a fabric to prepare the composite fabric detailed below.
Fabric: PET fabric, 75D×100D (denier) (84T×100T (decitex))
Fabric Size: 1530 mm×1000 mm
Synthetic Resin Layer Composition: SMPMM-2520 manufactured by SMP Technologies Co., Ltd.
Synthetic Resin Layer Size: Continuous film 150 mm×1,000 mm in size (FIG. 1)
Synthetic Resin Layer Thickness: 200 μm
Aperture Ratio: 25%
Number of Apertures per Unit Area: 74.4 /cm² (480 /inch²)

### COMPARATIVE EXAMPLE 1

For Comparative Example 1, fabric was prepared in the same manner as Example 1.

### COMPARATIVE EXAMPLE 2

For Comparative Example 2, a thermoplastic polyurethane rubber layer was formed over a fabric identical to that used in Example 1 and apertures were established on the rubber layer.
Rubber Layer Composition: E380 manufactured by Nippon Miractran Co., Ltd.
Rubber Layer Size: Continuous film 1,530 mm×1,000 mm in size (FIG. 1)
Rubber Layer Thickness: 200 μm
Aperture Ratio: 25%
Number of Apertures per Unit Area: 74.4 /cm² (480 /inch²)

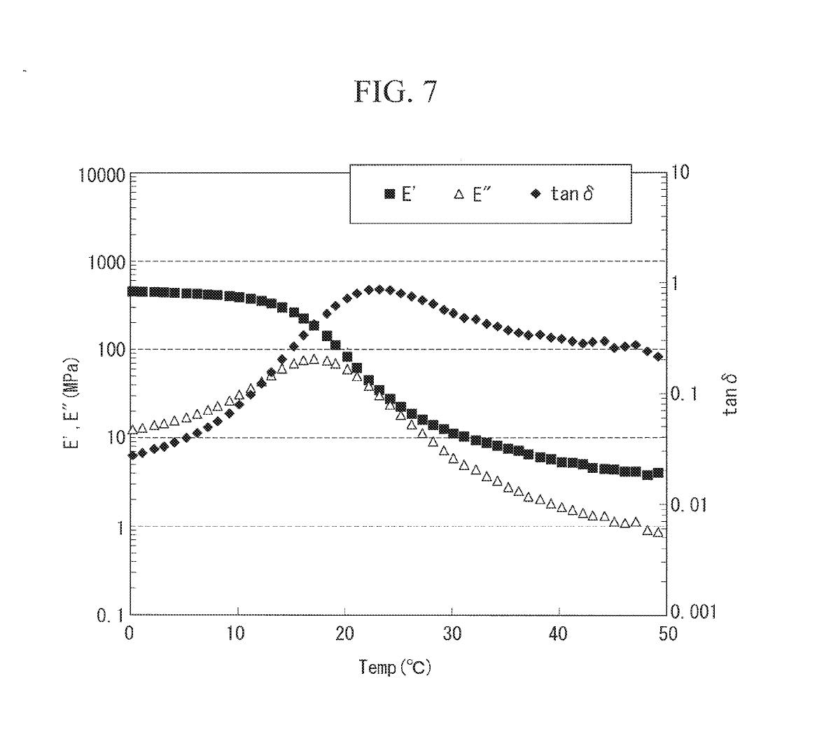

FIG. 7 is a graph showing dynamic viscoelasticity temperature dependence (0 to 50° C.) for Example 1.

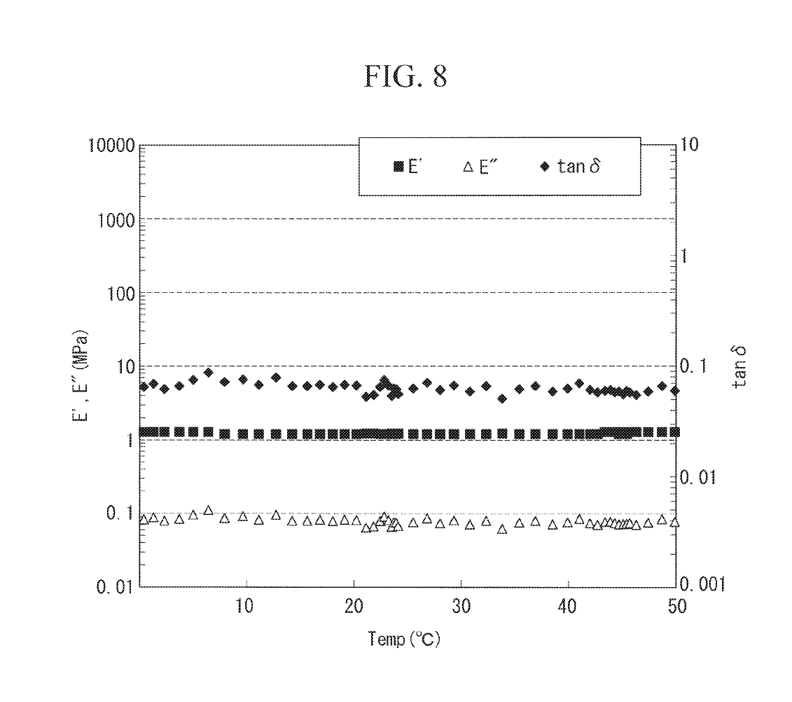

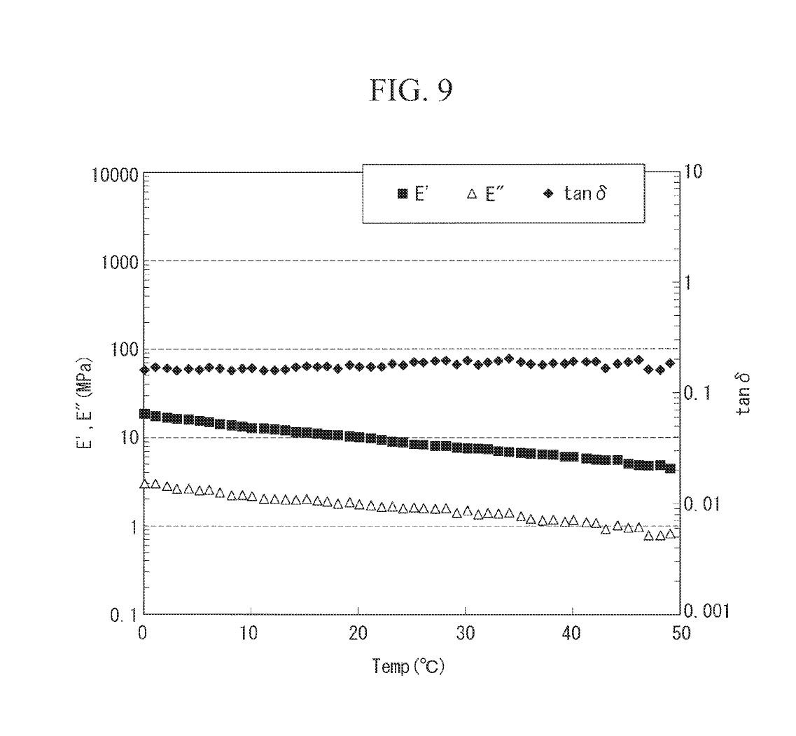

FIGS. 8 and 9 are graphs showing dynamic viscoelasticity temperature dependence (0 to 50° C.) for Comparative Examples 1 and 2 respectively.

In FIGS. 7 to 9 the horizontal axis represents temperature while the first vertical axis represents the storage elastic modulus E′ and the loss elastic modulus E″ and the second vertical axis represents tan δ. Here tan δ is the tangent of the ratio of the loss elastic modulus E″ to the storage elastic modulus E′ (E″/E′) at a frequency of 1.0 Hz.

The measurements shown in FIGS. 7 to 9 were made using a viscoelasticity measuring apparatus (TA Instruments Inc., RSA-G2). Measurement conditions were as follows: measurement frequency: 1.0 Hz; temperature range: −50 to 80° C.; rate of temperature increase: 5° C./min; measurement distortion: automatically variable from 1%; initial tension: 30 g (constant).

The composite fabric produced in Example 1 showed a tan δ maximum near 34° C. Because the composite fabric produced in Example 1 has a glass-transition temperature within range of the surface temperature of the human body, it is particularly comfortable when worn on the human body.

Note that then only the synthetic resin layer film was measured, a dynamic viscoelasticity temperature dependence similar to that shown in FIG. 7 was observed.

On the other hand, as shown in FIGS. 8 and 9, no tan δ temperature dependence was observed for Comparative Examples 1 and 2. That is, there was no glass-transition temperature observed not only for the fabric alone, but also when a polyurethane rubber layer was formed over the fabric. In other words, the comfort upon wearing of the fabrics produced in Comparative Examples 1 and 2 was inferior to that of the composite fabric produced in Example 1.

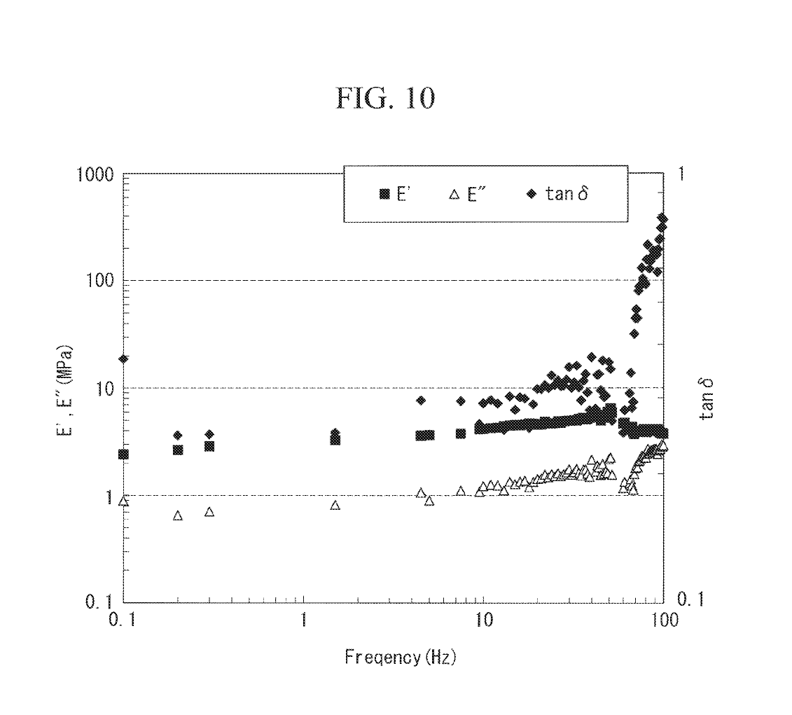

FIG. 10 is a graph showing the dynamic viscoelasticity frequency dependence observed for Example 1.

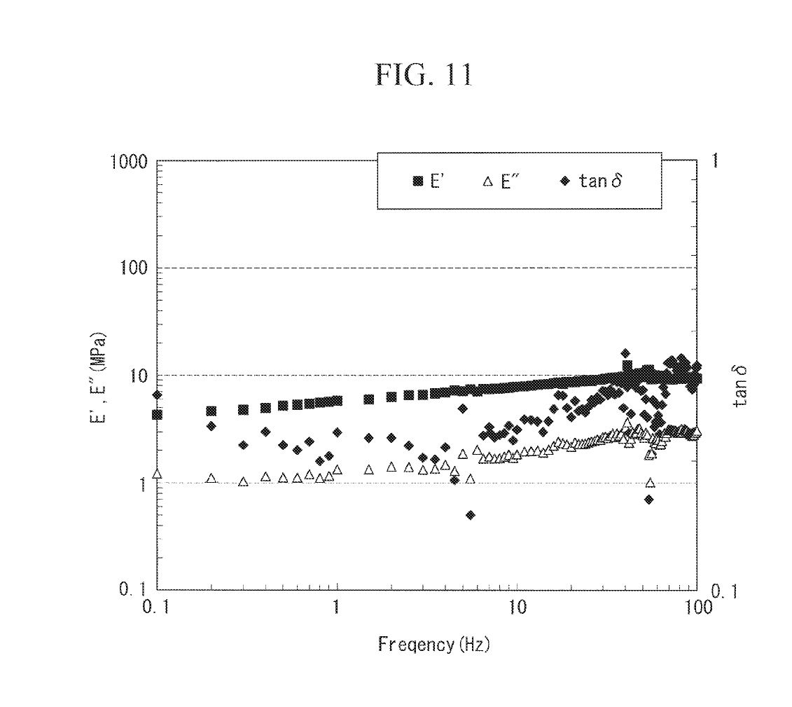

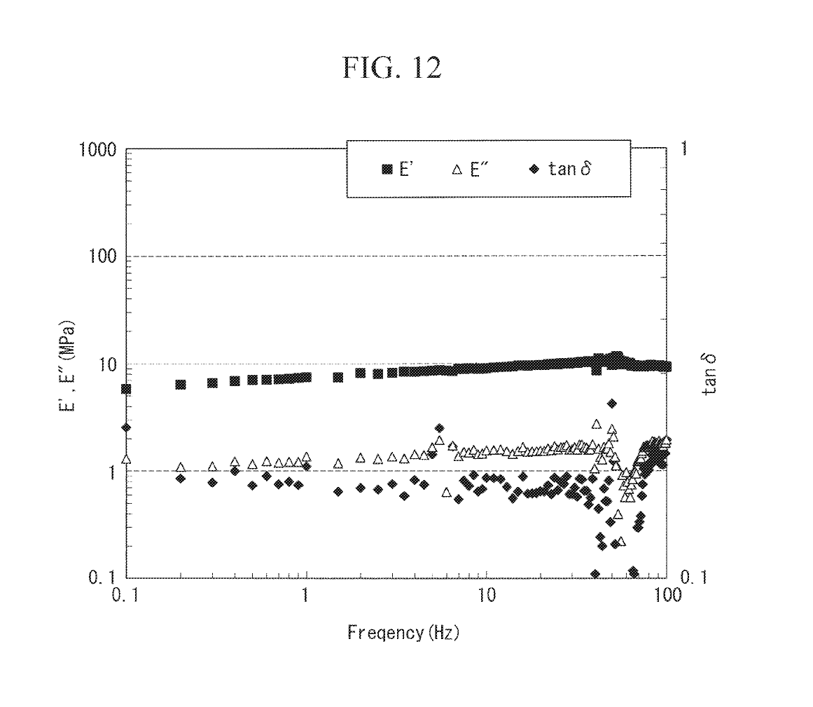

FIGS. 11 and 12 are graphs showing dynamic viscoelasticity frequency dependence for Comparative Examples 1 and 2 respectively.

In FIGS. 10 to 12 the horizontal axis represents frequency while the first vertical axis represents the storage elastic modulus E′ and the loss elastic modulus E″ and the second vertical axis represents tan δ. tan δ is the tangent of the ratio of the loss elastic modulus E″ to the storage elastic modulus E′ (E″/E′) at a temperature of 25° C.

The measurements shown in FIGS. 10 to 12 were made using a viscoelasticity measuring apparatus (TA Instruments Inc., RSA-G2). Measurement conditions were as follows: measurement temperature: 25° C.; measurement mode: tensile; displacement amplitude: set to 12.5 μm.

For the composite fabric produced in Example 1, tan δ was 0.25 or greater within a range of 0.1 to 100 Hz.

For the composite fabric produced in Example 1, E′ and E″ increased monotonically as frequency increased. That is, E′ and E″ were higher during exercise (10 to 100 Hz) than at rest (0.1 to 1 Hz) and tan δ increased with increasing frequency. In particular, frequency increased dramatically from 10 to 100 Hz. Based on these results, it is clear that the composite fabric produced in Example 1 reinforces the motion of human muscles during exercise without burdening the muscles during rest. Furthermore, the composite fabric produced in Example 1 is comfortable when worn on the human body, both when the body is at rest as well during exercise.

Note that then only the synthetic resin layer film was measured, a dynamic viscoelasticity frequency dependence similar to that shown above was observed.

On the other hand, for Comparative Examples 1 and 2, no increase in E′, E″ or tan δ was observed between 10 and 100 Hz. That is, the fabric obtained in Comparative Examples 1 and 2 cannot support the human body's muscles during exercise and these fabrics are also not necessarily comfortable when worn on the human body, either when the body is at rest or when the body is in motion.

### REFERENCE SIGNS LIST

100, 110, 200, 300, 400 Composite fabric
101, 111, 201, 301, 401 Fabric
102, 112, 202, 302, 402 Synthetic resin layer
103, 113, 203, 303 Apertures
304 Blocks

1. A film which is primarily composed of a polyurethane elastomer produced by via the polymerization of a bifunctional diisocyanate, bifunctional polyol and bifunctional chain extender using the pre-polymer method at a molar ratio of 2.00 to 1.10:1.00:1.00 to 0.10, which has multiple apertures at an aperture ratio of ranging from 10 to 90% (inclusive).

2. A film according to claim 1, wherein the number of apertures per unit area ranges from 30 /cm² to 150 /cm² (inclusive).

3. A film according to claim 1, wherein the molecular weight of the bifunctional diisocyanate ranges from 174 to 303, the molecular weight of the bifunctional polyol ranges from 300 to 2,500, and the bifunctional chain extender is a diol or diamine with a molecular weight ranging from 60 to 360.

4. A composite fabric composed of a fabric produced from natural fiber, synthetic fiber or a mixed fiber containing both the natural fiber and the synthetic fiber, as well as a synthetic resin layer which covers part of surface of at least one side of said fabric, wherein the synthetic resin layer is composed primarily of a polyurethane elastomer produced by via the polymerization of a bifunctional diisocyanate, bifunctional polyol and bifunctional chain extender using the pre-polymer method at a molar ratio of 2.00 to 1.10:1.00:1.00 to 0.10, and the coverage ratio of the synthetic resin layer relative to the surface of the fabric ranges from 10 to 90% (inclusive).

5. A composite fabric according to claim 4, wherein the synthetic resin layer contains multiple apertures, and the aperture ratio of the synthetic resin layer ranges from 10 to 90% (inclusive) while the number of apertures per unit area should ranges from 30 /cm² to 150 /cm² (inclusive).

6. A composite fabric according to claim 4, wherein the synthetic resin layer is a continuous film.

7. A composite fabric according to claim 4, wherein the molecular weight of the bifunctional diisocyanate ranges from 174 to 303, the molecular weight of the bifunctional polyol ranges from 300 to 2,500, and the bifunctional chain extender is a diol or diamine with a molecular weight ranging from 60 to 360.
